(19) United States
(12) Patent Application Publication
(10) Pub. No.: US 2013/0024369 A1
(43) Pub. Date: Jan. 24, 2013

(54) SYSTEMS AND METHODS RELATING TO DONATIONS

(71) Applicant: Steven Nargizian, Franklin Lakes, NJ (US)

(72) Inventor: Steven Nargizian, Franklin Lakes, NJ (US)

(21) Appl. No.: 13/556,163

(22) Filed: Jul. 23, 2012

Related U.S. Application Data
(60) Provisional application No. 61/579,977, filed on Dec. 23, 2011.
(60) Provisional application No. 61/510,754, filed on Jul. 22, 2011.

(51) Int. Cl. G06Q 40/00

(52) U.S. Cl. 705/40

(57) ABSTRACT

Systems and methods associated with making and acquiring donations (e.g., monetary gifts) utilizing communication links within a network (e.g., the Internet), an electronic platform (including a website), and the computer systems of parties to the system are provided. Pledges and/or donations and/or funds can be transmitted from one party to another. The pledges and/or donations may be contingent upon certain terms or conditions being met.

### RELATED APPLICATIONS

This application claims the priority of U.S. Provisional Application Ser. No. 61/579,977, filed Dec. 23, 2011, and U.S. Provisional Application Serial No. 61/510,754, filed Jul. 22, 2011, and the entire contents of these applications are expressly incorporated herein by reference.

### BACKGROUND OF THE INVENTION

### Field of the Invention

The present invention encompasses systems and methods associated with making and acquiring donations.

### SUMMARY OF THE INVENTION

The present invention encompasses systems and methods associated with making and acquiring donations (e.g., monetary gifts) utilizing communication links within a network (e.g., the Internet), an electronic platform (including a website), and the computer systems of parties to the system. Pledges and/or donations and/or funds can be transmitted from one party to another. The pledges and/or donations may be contingent upon certain terms or conditions being met.

### BRIEF DESCRIPTION OF THE DRAWINGS

The foregoing features of the invention will be apparent from the following Detailed Description of the Invention, taken in connection with the accompanying FIGS. in which:

FIG. 1 is a diagram showing an example of an embodiment of the system, where a “pledging party” makes a pledge that is contingent upon terms and/or conditions being met;

FIG. 2 is a diagram showing an example of an embodiment of a system and/or method of making and/or acquiring donations where donations are provided to different beneficiaries;

FIG. 3 is a diagram showing an example of an embodiment of a system and/or method of making and/or acquiring donations where multiple pledges are utilized within an offer.

FIG. 4 is a diagram showing an escrow separate from the system provider (fundraiser) that receives and distributes funds from numerous parties.

FIG. 5 is a diagram showing sample components that can be utilized within the system.

FIG. 6 is a diagram showing sample components of the processing server described in FIG. 5.

FIGS. 7-13 are computer generated screen images showing screens that could be presented to a user of the system.

FIGS. 14-15 are examples of electronic communications generated by the system.

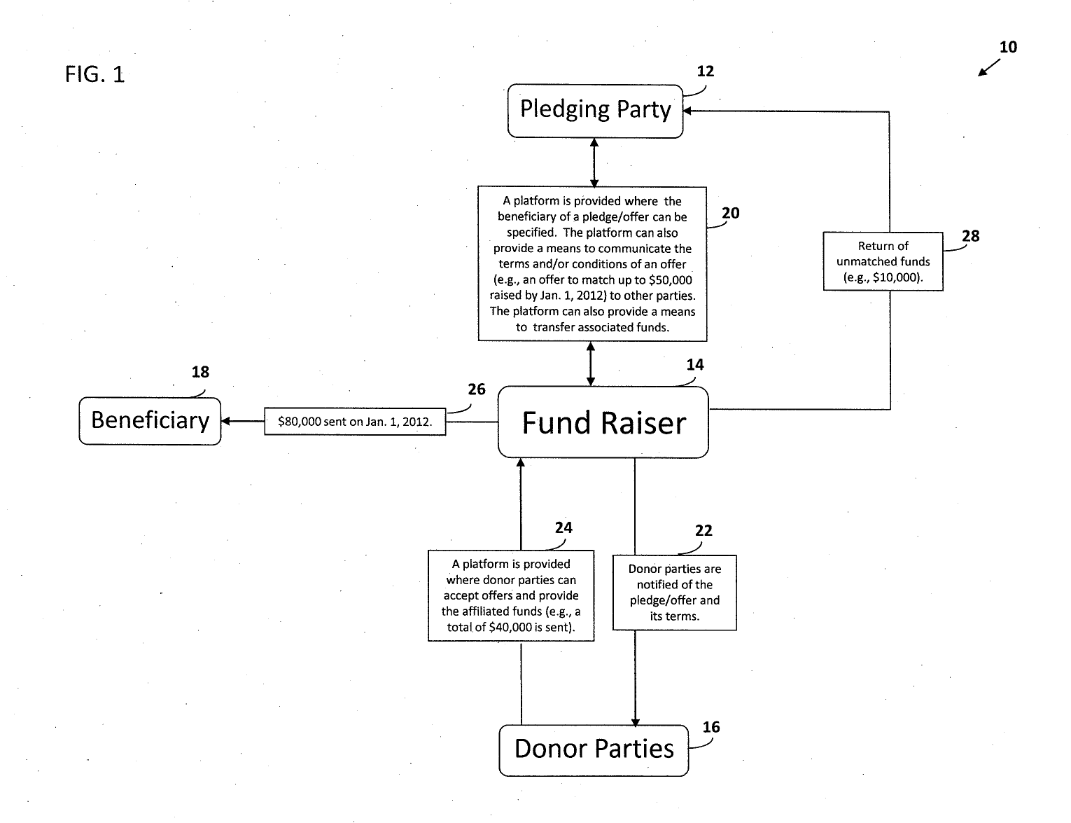

Examples of the present invention are discussed in detail below (e.g. in connection with FIGS. 1-4). These examples may contain information such as dates and/or monetary amounts for illustrative purposes, and are not intended to limit the spirit or scope of the invention. Furthermore, the systems and methods described herein can be modified or varied without departing from the spirit or scope of the invention.

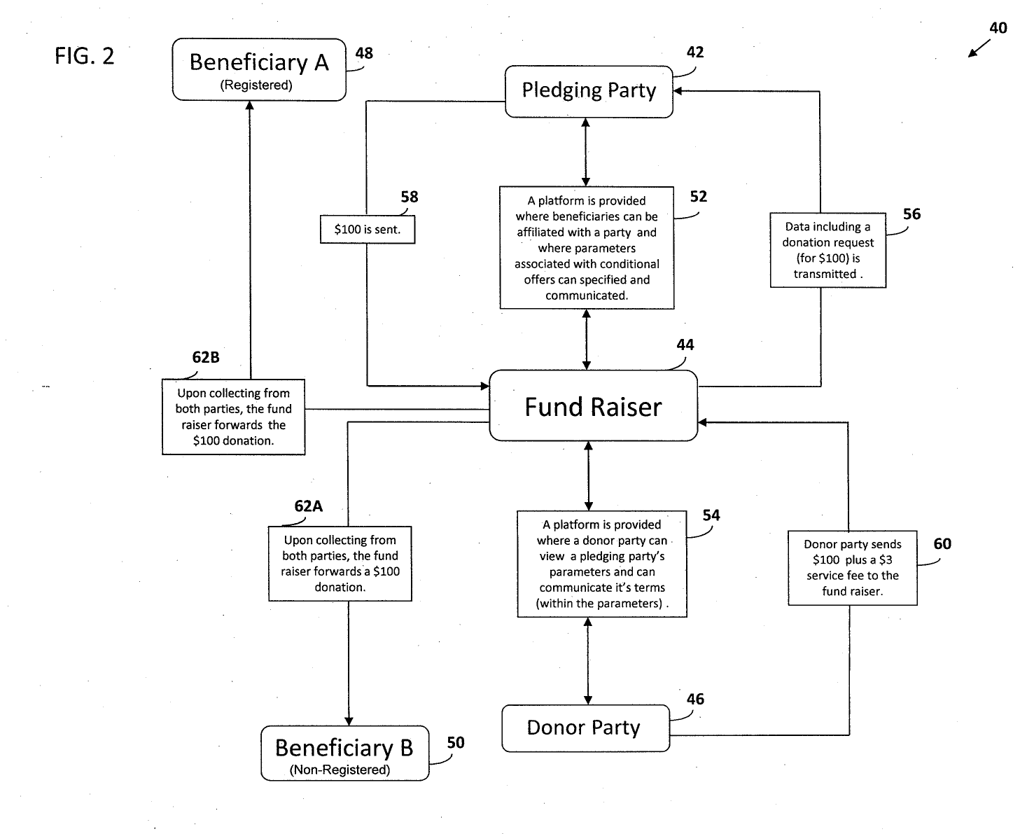

Moreover, there are options and/or features that may be provided, for example, in connection with FIG. 1, which could be similarly provided in connection with FIG. 2, as would be understood by one having ordinary skill in the art. Furthermore, while the figures show method steps; processes, and/or transmissions which are numbered in order, it should be pointed out that the order in which they are performed may not be the only order in which they can be effectively provided. Lastly, references to a party herein may include reference to the party's computer system.

### DETAILED DESCRIPTION OF THE INVENTION

The present invention encompasses systems and methods associated with making and acquiring donations (e.g., monetary gifts) utilizing communication links within a network (e.g., the Internet), an electronic platform (including a website), and the computer systems of parties to the system.

FIG. 1 is a diagram showing an example of an embodiment of the system (indicated generally by 10), where a pledging party 12 customizes a pledge/offer that is contingent upon the terms and/or conditions that he/she specifies. Such terms and/or conditions may include the designation of the pledge beneficiary. For example, as per block 20, using the system the pledging party 12 could communicate a pledge (to donor parties 16) to donate up to $50,000 to beneficiary 18, provided that, for example, an equal sum of money is donated to beneficiary 18 by the donor parties 16, by a specified time (e.g., Jan. 1, 2012), etc. The pledge could also be communicated to beneficiary 18. Additional terms and/or conditions associated with the general use of the system (e.g., donations must be made exclusively through the system) may also apply. Such communications can be made anonymously or where the party's identity is made known.

Depicted in FIG. 1, the pledging party 12 sends $50,000 to the fund raiser 14 (also acting as an escrow). Pledging parties may be required to provide pledged funds to an escrow (which could also be an independent escrow service) in advance of the affiliated pledges being communicated to other parties. Furthermore, pledging parties can provide the system with the contact information (e.g., e-mail addresses) of potential donor parties, to help publicize offers.

Via a network (e.g., the Internet), data describing the offer can be transmitted to the affiliated beneficiary 18, as can requests for contact information of potential donor parties (if not pre-provided). As per block 22, donor parties 16 are presented with the offer and are provided with a platform where they can communicate acceptance of the offer and send the affiliated funds, as depicted in block 24. As per this example, a total of $40,000 is sent to the fund raiser 14 (escrow) by various donor parties 16. Such funds can be affiliated with specific offers, and the system can be programmed to provide detailed reports and accounting services.

As depicted in block 26, upon expiry of the pledge/offer, the fund raiser 14 can send the funds (e.g., $40,000) donated by donor parties 16, and the matching funds (e.g., $40,000) donated by the pledging party 12, to the beneficiary 18. An option can be provided to pledging parties where part, or all, of any unmatched portion of a pledge can also be donated, or as described in block 28, the unmatched portion (e.g., $10,000), can be returned to the pledging party 12 (as well as any pre-provided service fees). As per this example, a total of $80,000 was provided to beneficiary 18.

Moreover, the system can be implemented where service fees can be charged to any party using the system. For example, a platform can be provided, where beneficiaries can pre-agree to pay the service fees affiliated with future donations made to them (via the system). Beneficiaries may or may not have governmental recognition as non-profit organizations. The parties referenced throughout the figures and specification can be individuals or various entities, including (but not limited to) corporations, non-profit organizations, govt. entities, charities, charitable trusts, etc. Additionally, the system can vet and/or validate information provided by the parties to the system.

FIG. 2 is a diagram showing an example of another embodiment of the system, indicated generally by 40. As depicted in block 52, a platform is provided where a pledging party 42 can affiliate itself with beneficiaries to which the pledging party 42 is partial (e.g., Beneficiary A 48). As per FIG. 2, the pledging party 42 pledges to match (e.g., up to $100) donations (as provided in connection with the pledge) to Beneficiary A 48, with a donation of equal value (other values can be proportionally specified) to a beneficiary (e.g., Beneficiary B 50), specified by another party (e.g., Donor Party 46). As described, the system can provide a means where pledging parties have an opportunity to review pertinent information (e.g., the identity of beneficiary B 50) prior to a final acceptance.

As per block 54, the donor party 46 visits a webpage associated with the pledging party 42, is made aware of the pledging party's pledge/offer (if the donor party 46 is not already aware), and is provided with a platform to communicate his/her intentions (e.g., to donate $100 to Beneficiary A 48) and to specify a beneficiary (e.g., Beneficiary B 50) to be affiliated with the pledging party's pledge/offer. As per block 56, pertinent data, notification regarding the donor party's intent, and a request for a donation (e.g., $100) is transmitted to the pledging party 42.

As described within block 58, the pledging party 42 sends $100 to the fund raiser 44 (also acting as an escrow). Not depicted within the diagram, notification that the pledged funds (e.g., $100) have been provided (to the escrow) and a request for the promised donation (e.g., $100) and service fee (e.g., $3) is transmitted to the donor party 46. As depicted in block 60, a $100 donation and a $3 service fee is sent from the donor party 46 to the fund raiser 44. The order of the method steps can vary. Upon collecting the funds from both parties, the fund raiser 44 (escrow) forwards the $100 donation (made by the pledging party 42) to Beneficiary B 50, as depicted by block 62A. And as described in block 62B, the $100 donation (made by the donor party 46) is forwarded to Beneficiary A 48. For various reasons (e.g., tax reasons, etc.) the donations can be provided to the beneficiaries by the parties who specified them, rather than the corresponding party. The systems and methods described herein are ideally suited for implementation within, or as, a social network (particularly the embodiment associated with FIG. 2).

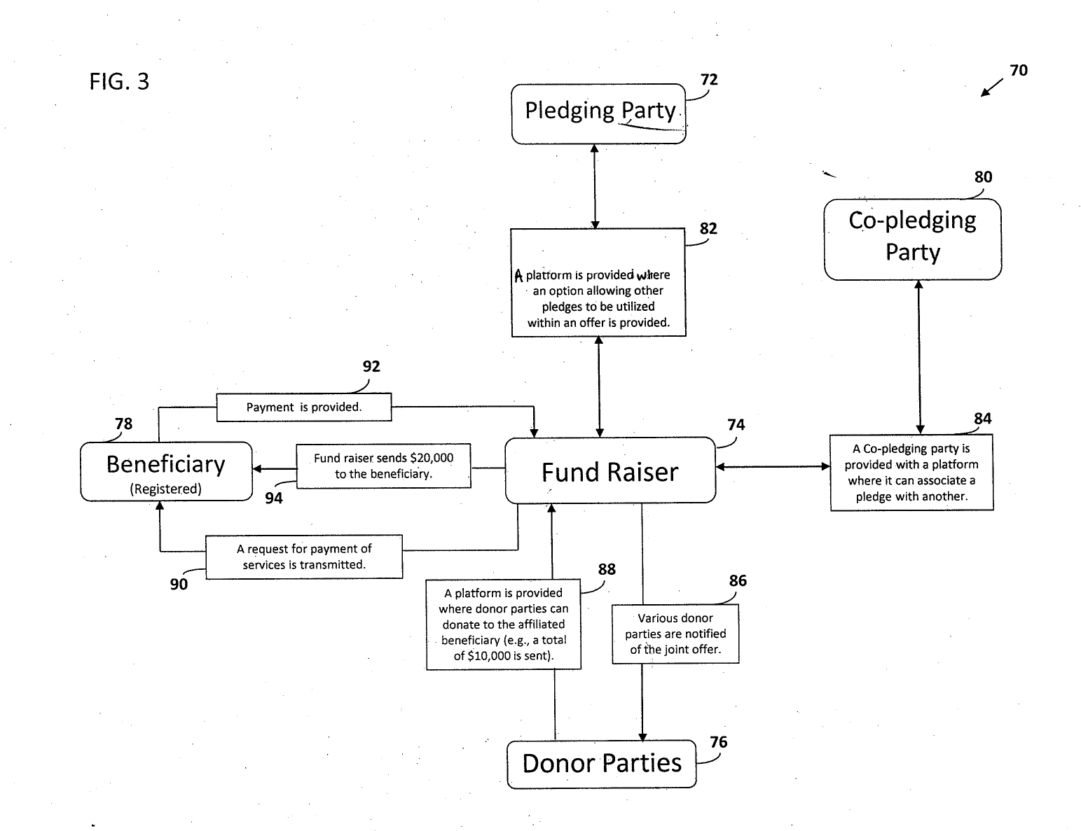

FIG. 3 is a diagram showing an example of an embodiment of the system, indicated generally by 70 where multiple pledges (made by multiple parties) are utilized within a single offer, providing unique benefits. Here, (as per other embodiments) a platform is provided where a pledging party 72 can customize the terms and/or conditions of pledges/offers (e.g., to match up to $5,000). As depicted in block 82, the platform can also provide a pledging party 72 with an option to solicit the participation of others within the offer. For example, as depicted in block 84, a co-pledging party 80 is notified of the co-pledging opportunity, and pledges $5,000 (to be added to the funds previously pledged).

Furthermore, a pre-existing blanket pledge (e.g., provided by a co-pledging party 80) can be incorporated into a pledging party's pledge. This implementation could ideally be used in connection with a company matching offer program.

As depicted in block 86, the system can notify various donor parties 76, describe the scope of the offer to them, and provide them with a platform for the transmission of associated funds. As described by block 88, the donor parties 76 send a total of $10,000 to the fund raiser 74 (via multiple donations). Payment methods can vary.

As is the case provided by the example depicted in FIG. 3, the beneficiary 78, may have previously registered within the system and may have pre-agreed to pay any service fees. As depicted by block 90, upon a stated expiry or attainment of a goal, a request can be sent from the fund raiser 74, to the beneficiary 78, for payment of services (along with a detailed description of the charges), and as per block 92, a payment of service fees can be made. Finally, as per block 94, the fund raiser 74, forwards the donations to the beneficiary 78.

This embodiment of the system can be used to create offers where pledges are accrued with other pledges, creating a larger pool of funds, so as to achieve larger goals. Alternatively, the system can be implemented or utilized where pledges are affiliated within a single offer, but not accrued, providing donor parties with additional incentive. For example, using this method, dollar for dollar pledges can be made by multiple parties, but the goal affiliated with the donor party donations is based solely upon the initial amount pledged. Here, donor parties are presented with a donation/pledge ratio (e.g., for every dollar donated by a donor party, three additional dollars will be donated). Depending upon how the system is implemented and/or utilized, unmatched pledge amounts can be returned, or added to the total donation.

As previously mentioned, an independent escrow may be utilized to receive funds and distribute the same as instructed. Such an escrow can insure/guarantee that pledges are kept. The escrow can be in communication with transacting parties (opposite parties to the escrow, e.g. a pledging and a donor party) over a network such as the Internet. The escrow can receive funds from transacting parties and can distribute same in accordance with instructions from a program manager as provided by the transacting parties. Because the escrow receives funds from the pledging party it provides, it provides assurance to donor parties that the pledges are kept and donations are matched.

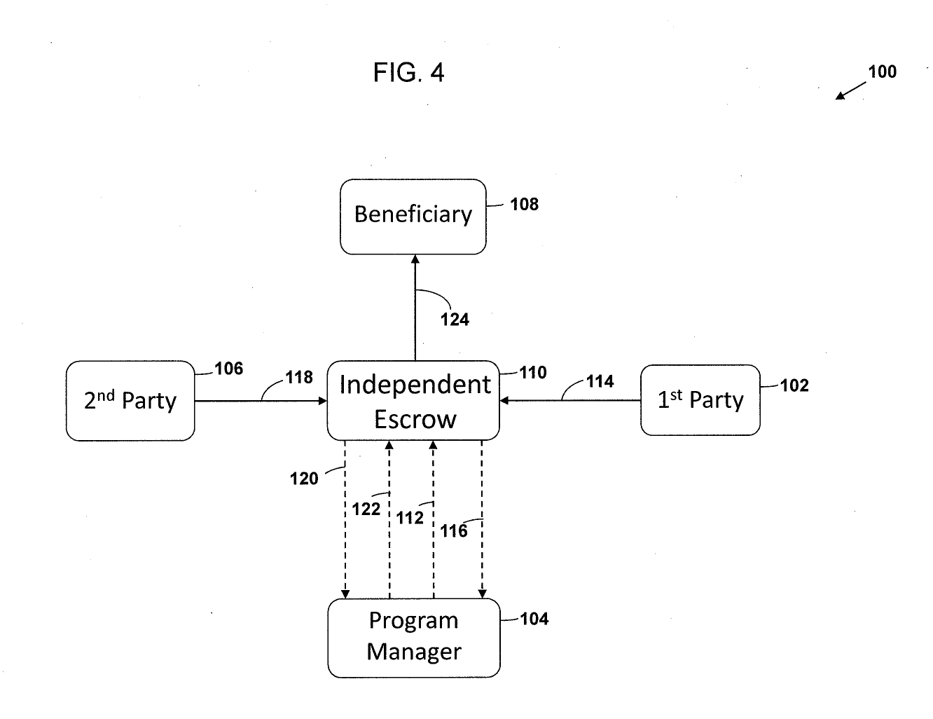

FIG. 4 is a diagram showing processing steps performed by an independent electronic escrow service 110. Here, the transacting parties 102, 106 to an escrow account (each party could represent multiple persons or entities acting individually) can provide funds to the escrow 110. As shown in FIG. 4, a program manager 104 (such as a fund raiser) can be provided with a means to communicate with the escrow 110 via an application programming interface (e.g., provided by the escrow 110) within an electronic network (e.g., the Internet). As shown by line 112, the program manager 104 can transmit instructions (e.g., in conjunction with a numerical code) to the independent escrow 110, to form an (escrow) account on behalf of a first party 102 (which could be identified, for example, by a particular name, number or code). As per this example and shown by line 114, the first party 102, having been provided with a numerical code, could electronically transfer funds to the escrow 110 in conjunction with the numerical code (which could be used by the escrow 110 to identify the applicable account). Furthermore, via multi-lateral or terms of use agreements, the first party 102 can designate the program manager 104 as agent to the (escrow) account, with the full power to determine the destination of funds provided by the first party 102. As shown by line 116, upon receiving such funds, the escrow 110 can transmit notice (of the receipt) to the program manager 104.

As shown by line 118, the escrow 110, receives a second electronic fund transfer pertaining to the same (escrow) account (as provided by a correlating numerical code) from an opposite party (the second party 106) to the account, via the network. Multi-lateral or terms of use agreements could provide that the program manager 104 shall be authorized (by the second party) to act as an agent on behalf of the second party, with the full power to determine the destination of funds (provided by the second party) held within the account. Shown by line 120, details regarding the second party's electronic fund transfer are transmitted to the program manager 104 from the escrow 110, and as shown by line 122, payment authorization and instructions can be communicated to the escrow 110 through the network. Finally, as shown by line 124, funds are transferred to a third party beneficiary 108 in accordance with all pertaining agreements. Not shown in FIG. 4, the escrow 110 could provide payment confirmation to parties of the system.

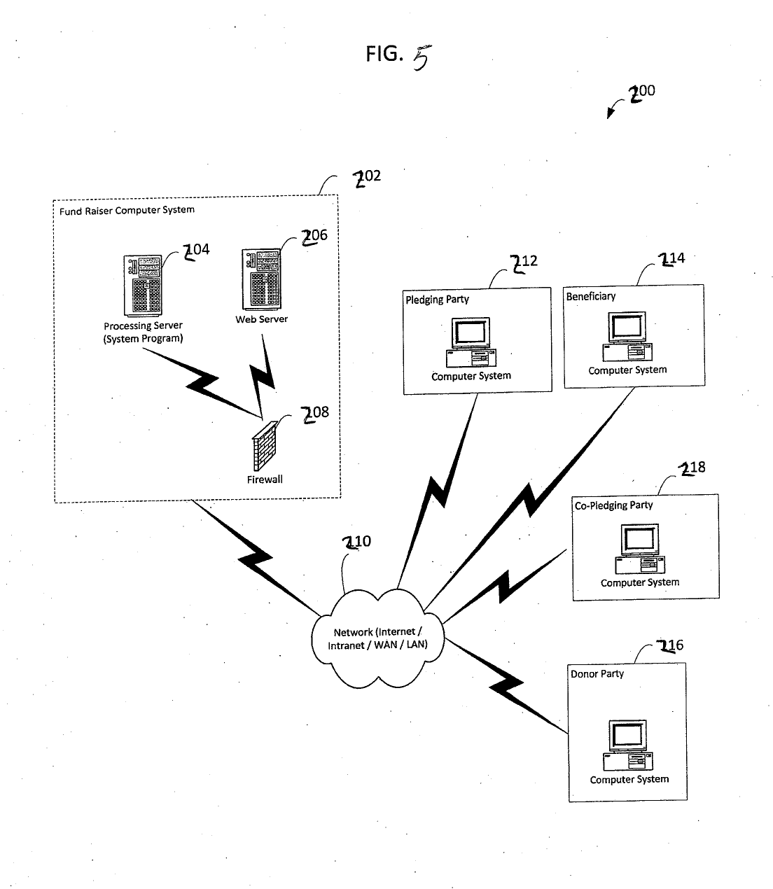

FIG. 5 is a diagram showing sample components that can be utilized to implement the present invention. The components depicted and discussed herein are not intended to limit the spirit or scope of the present invention. The system 200 of the present invention can be implemented via a network 210, using a first communication link between a pledging party computer system 212 and a fund raiser computer system 202 for communications concerning donations. A second communication link between the fund raiser computer system 202 and a donor party computer system 216 could enable similar communication. Such communication could encompass the sending and receiving of data and funds from party to party. Communication links between the fund raiser computer system 202 and a beneficiary computer system 214 and/or a co-pledging party computer system 218, could be similarly utilized via a network 210.

Examples of a network 210 could include: the Internet, an intranet, a wide area network (WAN), a local area network (LAN), etc. The computer systems 212, 214, 216, and 218 could each be any suitable computer system having the ability to communicate via a network 210 (e.g., having Internet connectivity), which may for example, be similar to the fund raiser computer system 202, and could include a personal computer, a laptop computer, a tablet computer, a smartphone, etc. A fund raiser computer system 202 could include servers 204 and 206, could include single or multiple processors (or a single processor having multiple processor cores), and could include any suitable operating system and associated system software, such as the UNIX operating system, Linux, Microsoft Windows, etc. Furthermore, the functions performed by the servers 204 and 206 could be provided by a single computer system, or by multiple networked computer systems (e.g., “cloud” or “grid” computing).

As depicted in FIG. 5, a fund raiser computer system 202 could include a processing server 204, which could provide much of the functionality and processing described throughout the specification. A web server 206 can host a web site that could be utilized as previously described, and a firewall 208 can provide security for the fund raiser computer system 202. It shall be understood that the method steps associated with the present invention could be performed, at least in part, via computer-executable instructions stored on computer-readable media.

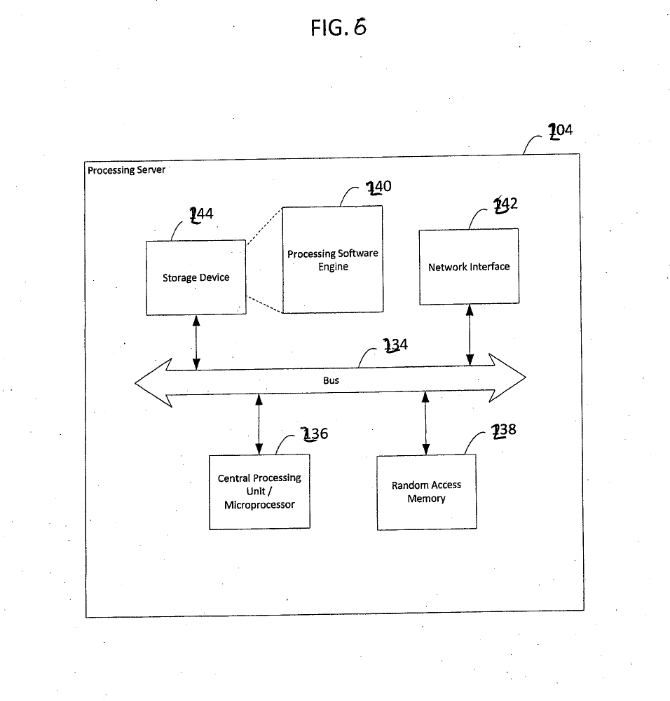

FIG. 6 is a diagram showing components of the fund raiser processing server 204 (depicted in FIG. 5) in greater detail. The server 204 could include a storage device 244 which could comprise any suitable computer-readable storage medium such as disk, non-volatile memory (e.g., EPROM, EEPROM, a flash memory, etc.), as well as a network interface 242, a communications bus 234, a central processing unit (e.g., incorporating a single or multiple-core microprocessor) 236, a random access memory (RAM) 238, etc. Much of the functionality provided by the present invention could be provided by a processing software engine 240, which could be embodied as computer-readable program code stored on the storage device 244 and executed by the CPU 236 using any suitable, high or low level computing language, such as Java, C, C++, C#, .NET, etc. The network interface 242 could include an Ethernet network interface device, a wireless network interface device, or any other suitable device which permits the fund raiser computer system to communicate via a network.

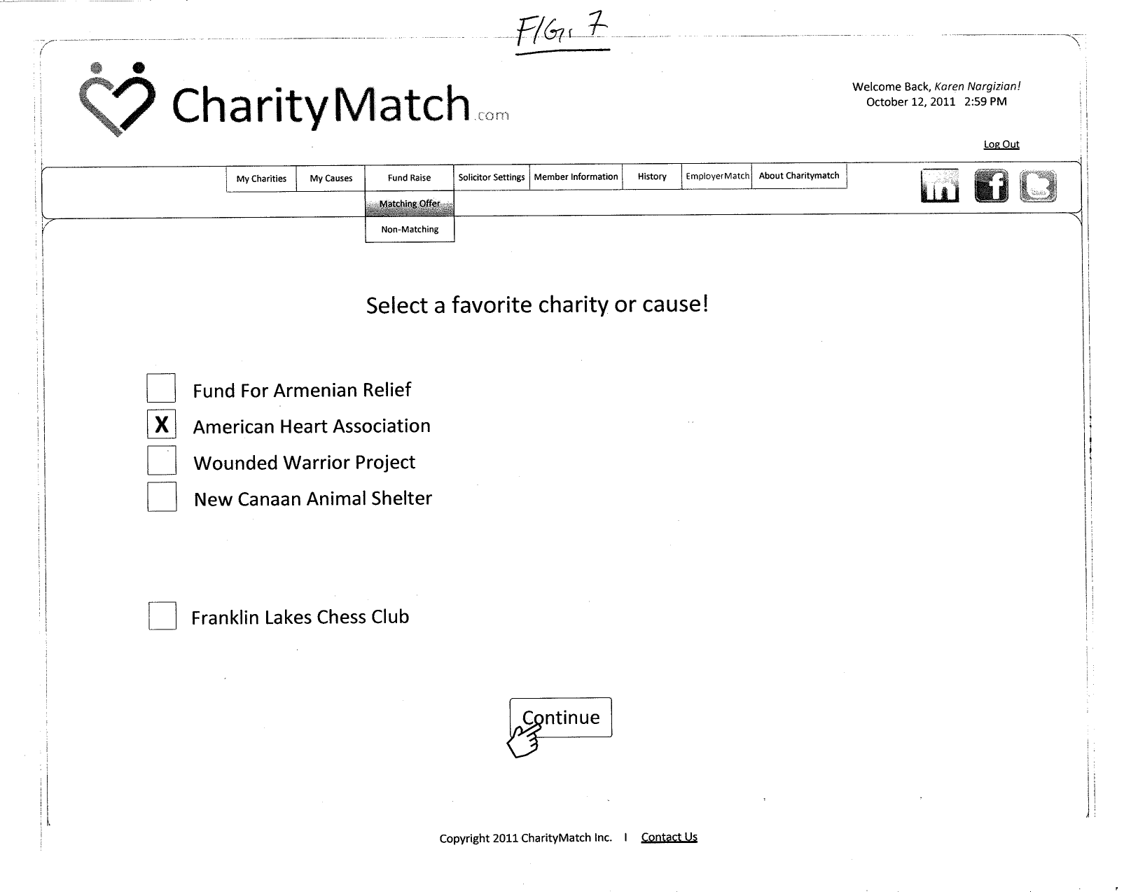

FIG. 7 is an example of a screen shot where a user can select a charity to be a beneficiary of a fundraiser.

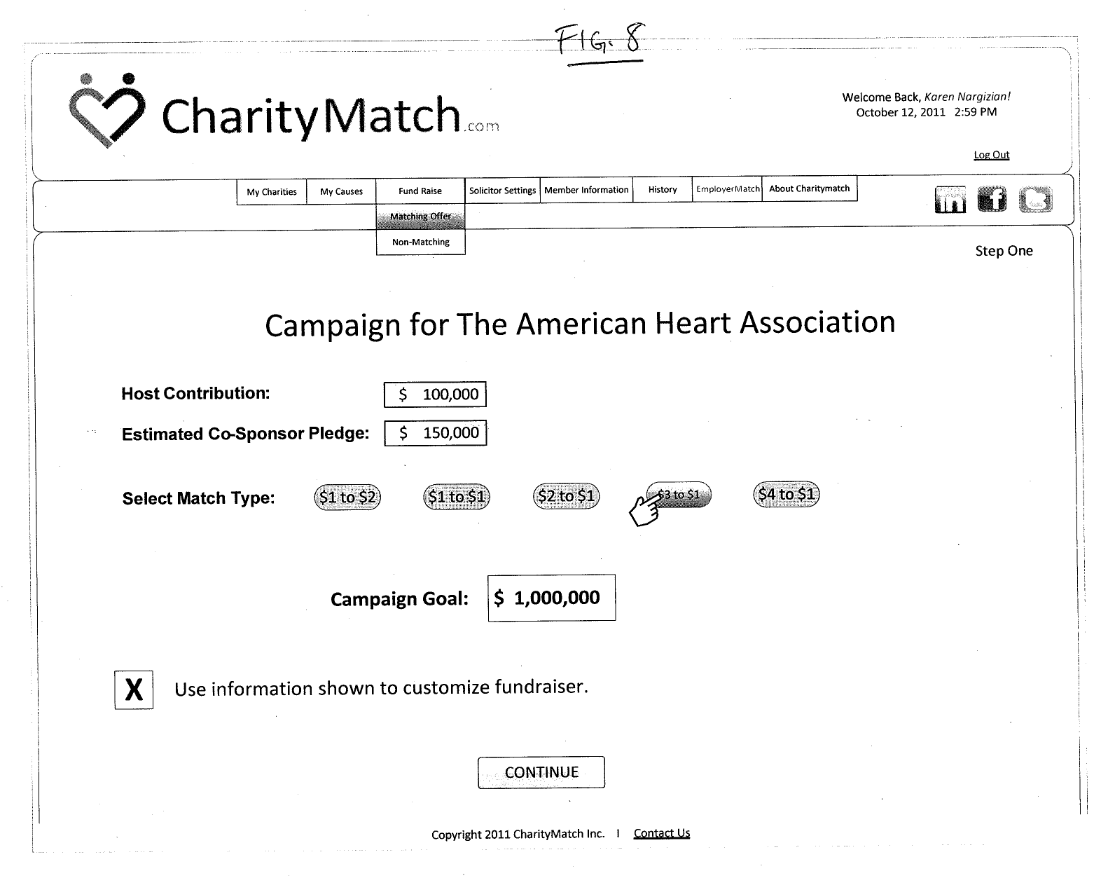

FIG. 8 is an example of a screen shot showing a user interface selecting a fundraiser type.

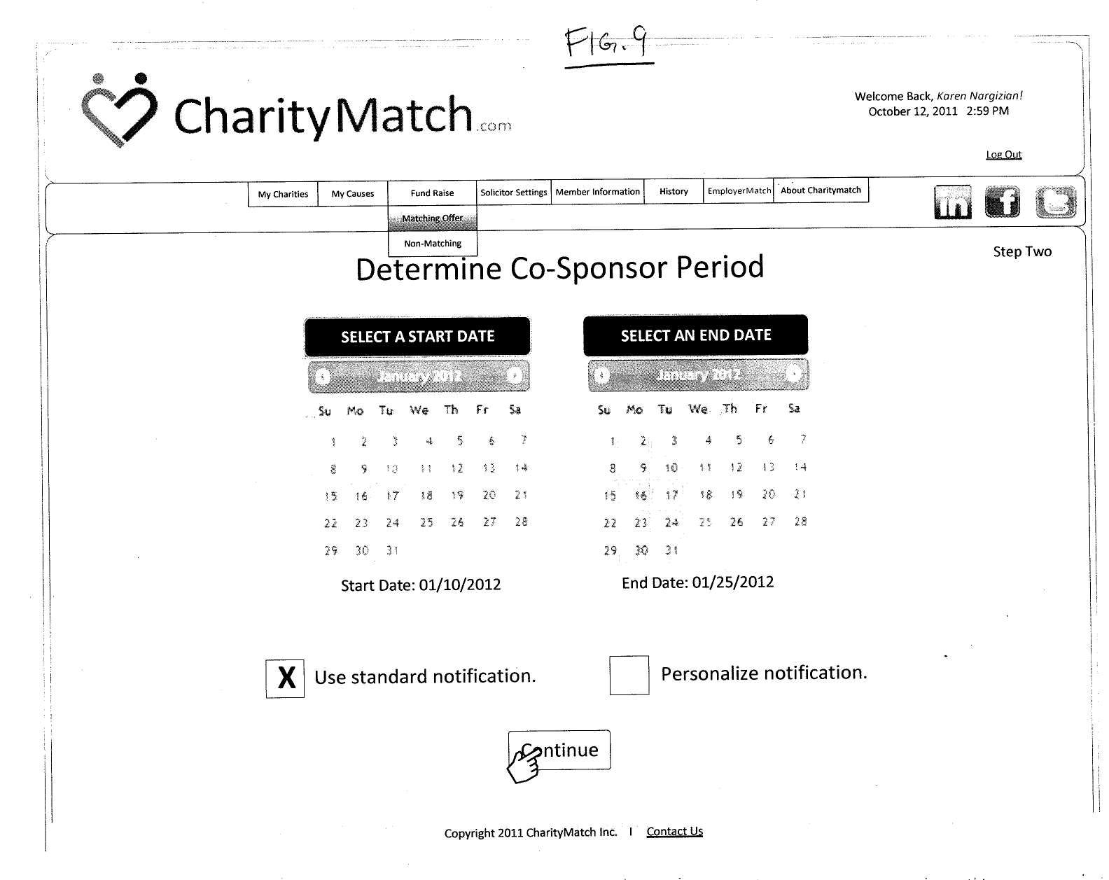

FIG. 9 is an example of a screen shot showing a user interface for determining a co-sponsor period.

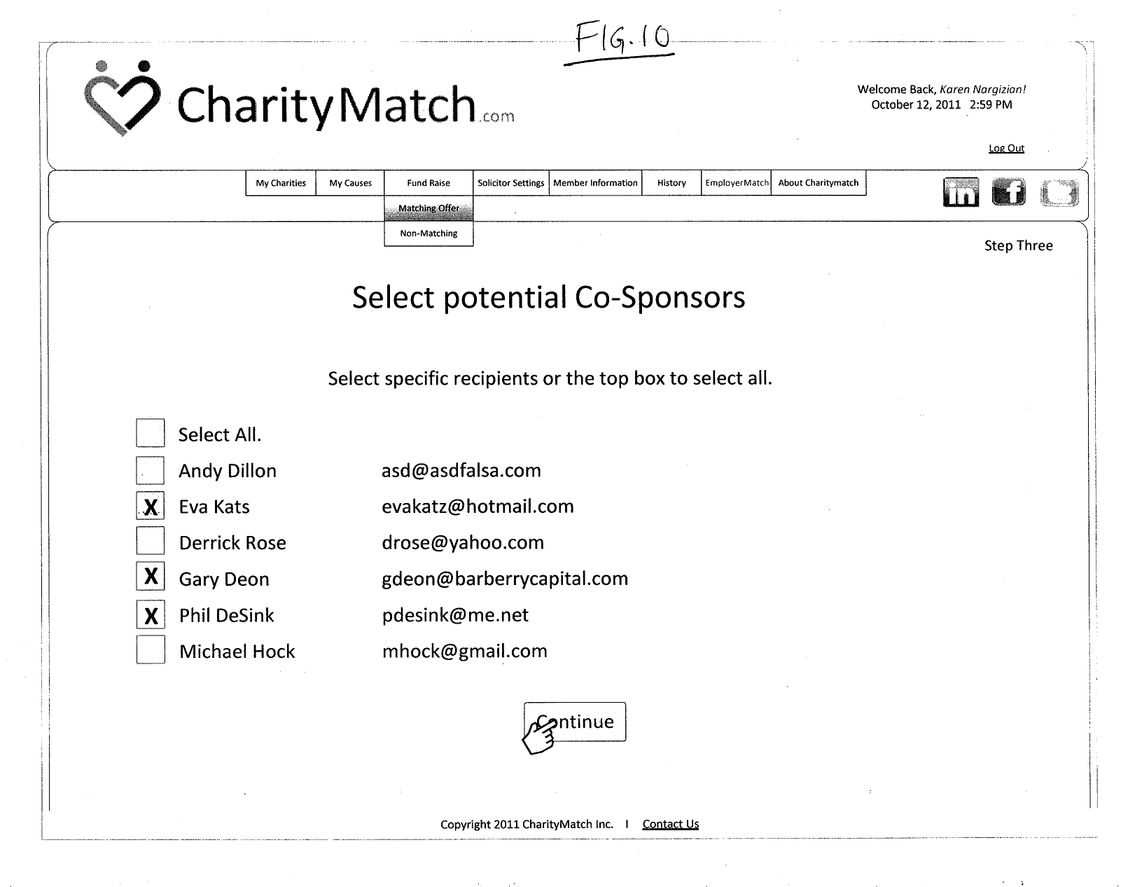

FIG. 10 is an example of a screen shot showing a user interface for determining potential co-sponsors.

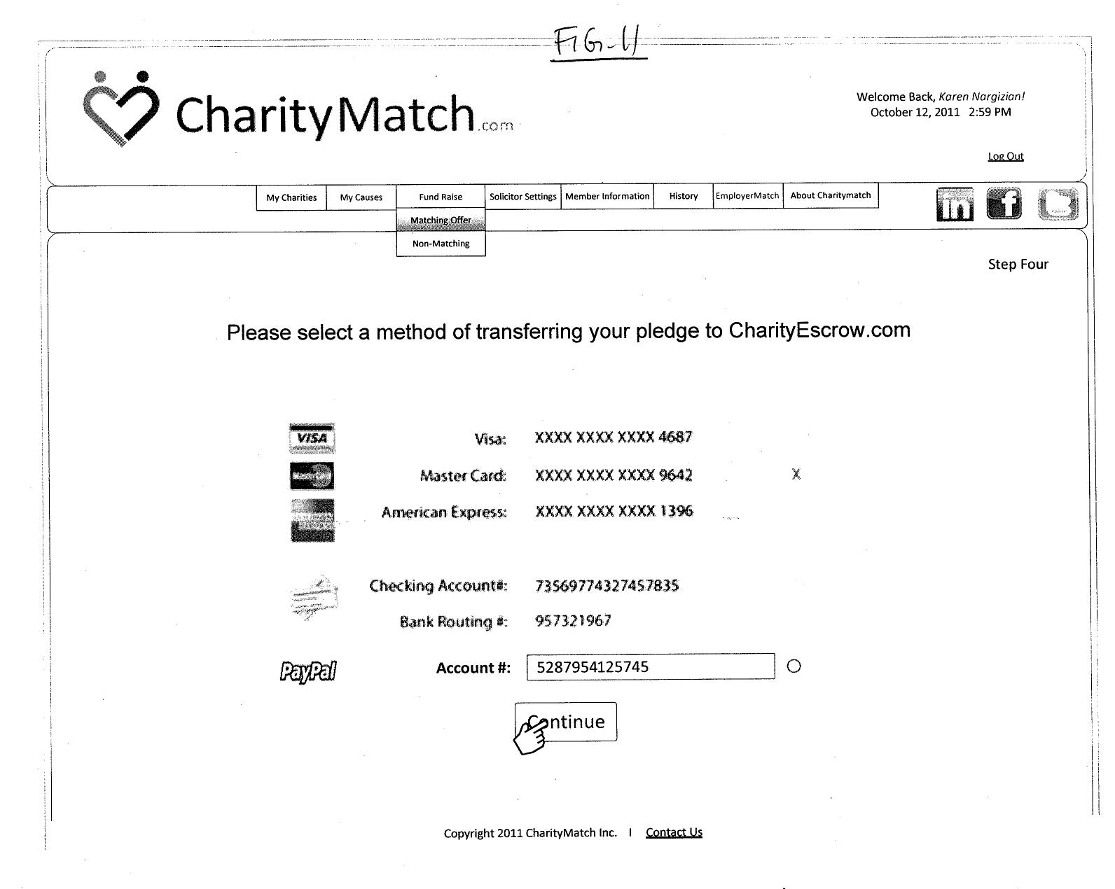

FIG. 11 is an example of a screen shot showing a user interface showing for choosing a payment method.

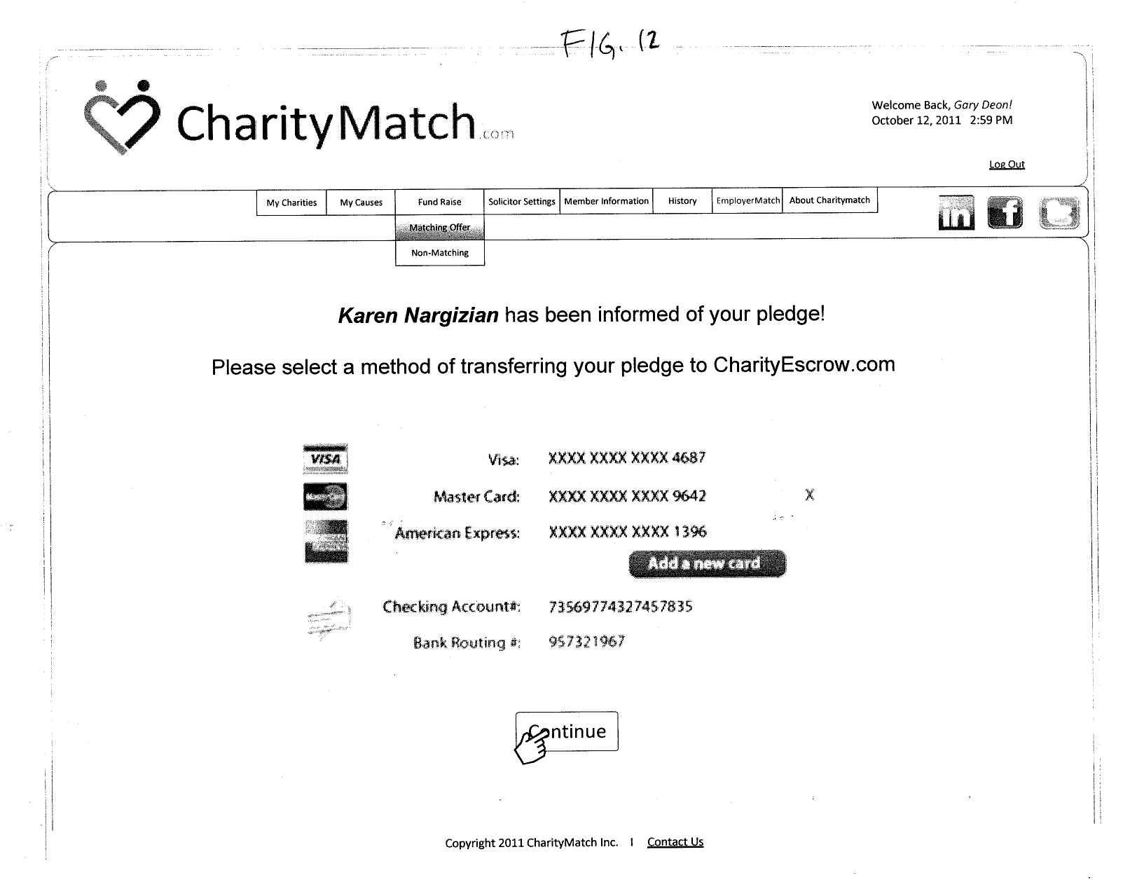

FIG. 12 is an example of a screen shot showing a co-pledging party that the pledging party has been informed of the co-pledge.

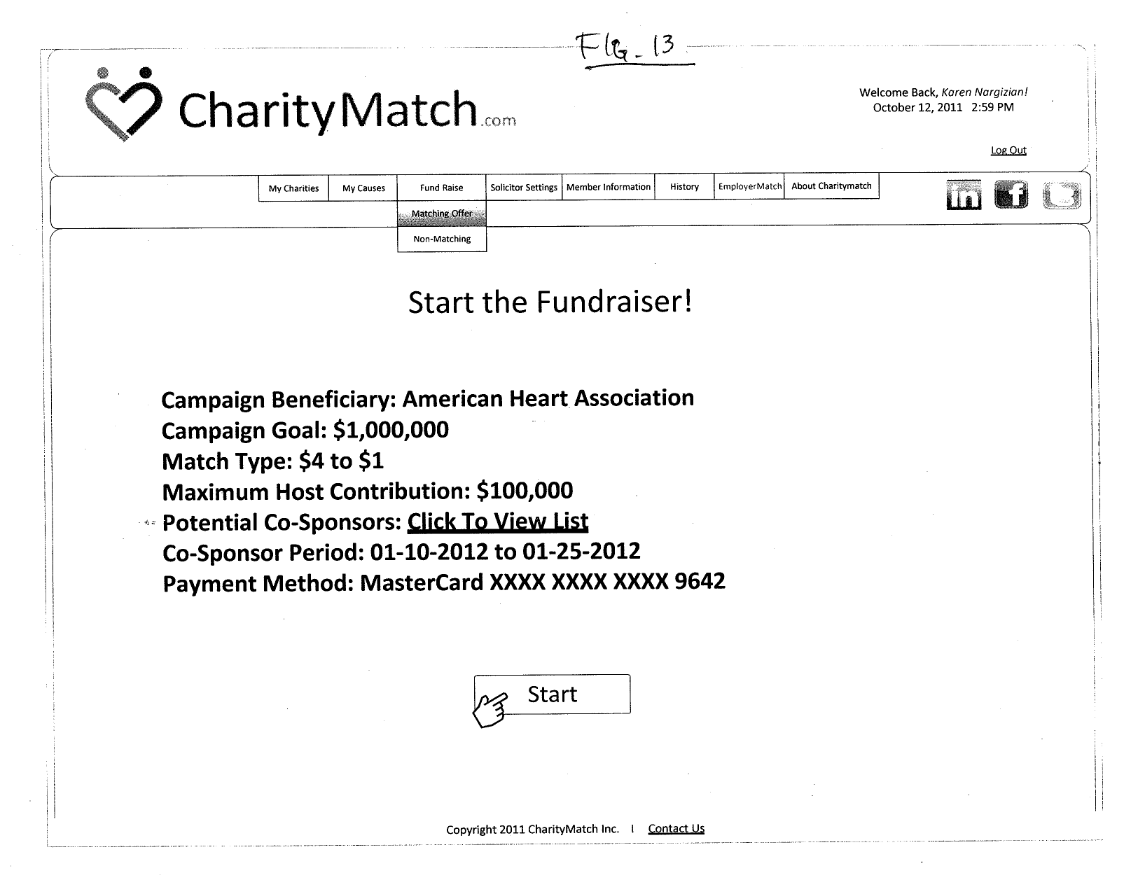

FIG. 13 is an example of a screen shot depicting a summary page for a fundraising campaign.

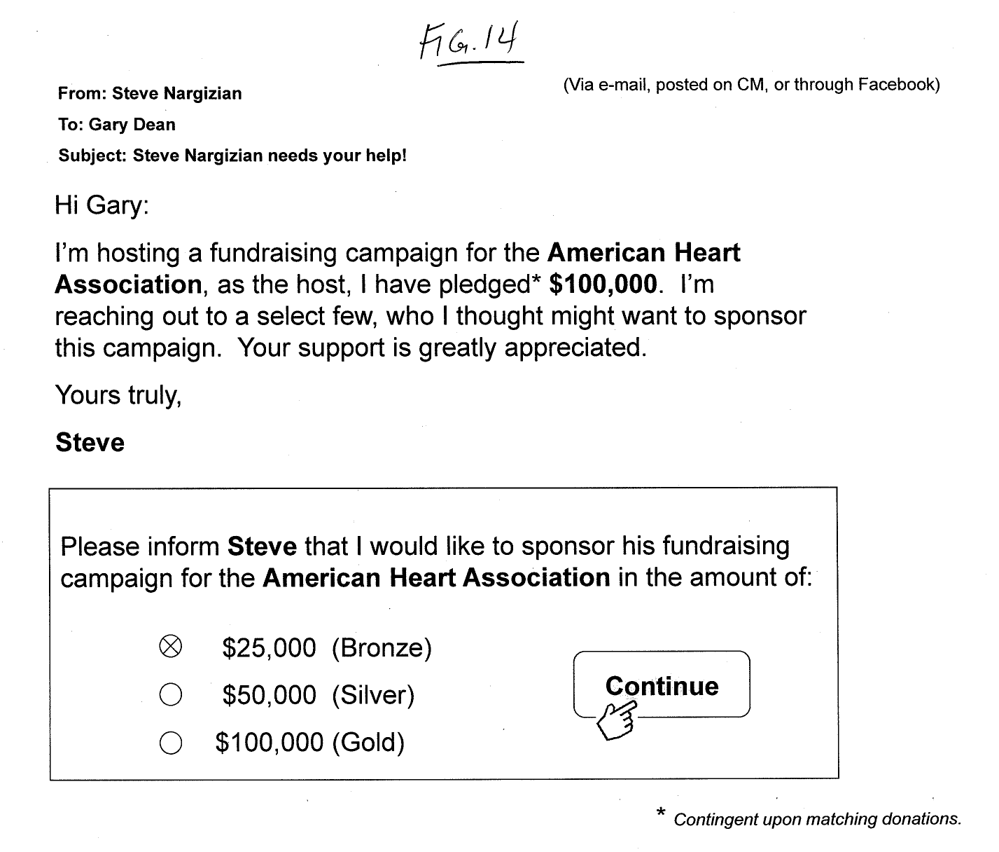

FIG. 14 is an example of an electronic communication to a potential co-pledging party.

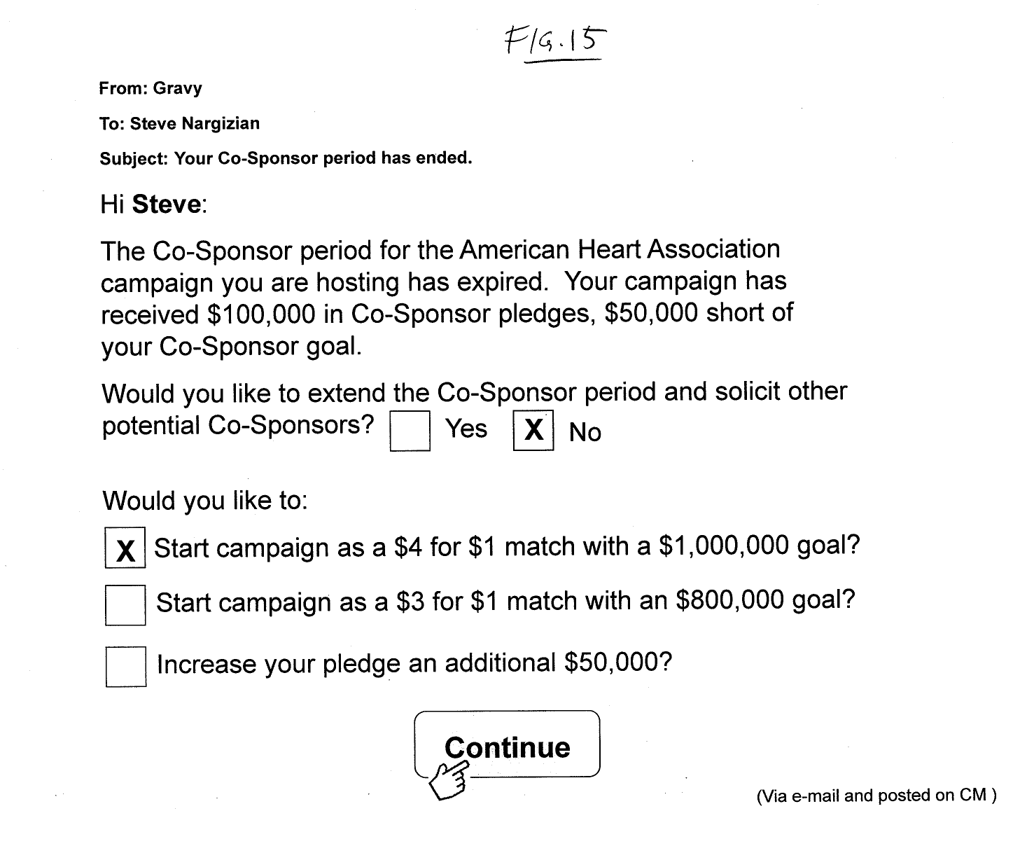

FIG. 15 is an example of an electronic communication that provides an initial pledging party with an option to prolong a co-pledging period.

Having thus described the present invention in detail, it is to be understood that the foregoing description is not intended to limit the spirit or scope thereof. The embodiments of the present invention described herein are merely exemplary, and a person skilled in the art may make many variations and modifications without departing from the spirit and scope of the invention. All such variations and modifications are intended to be included within the scope of the invention, as defined by the claims.

What is claimed is:

1. A method for fund raising comprising:
providing a pledging party with access to an electronic platform where a pledge can be made that is conditional upon the donation of funds by a donor party;
electronically communicating the conditional pledge to potential donor parties; and
providing the donor with an electronic platform to donate funds relating to the pledge.

2. The method of claim 1 wherein the step of electronically communicating information about the conditional pledge to potential donor parties comprises posting information about the conditional pledge on an electronically accessible website.

3. The method of claim 1 comprising obtaining information from donor parties, with respect to beneficiaries that are of interest to the donor parties.

4. The method of claim 3 further comprising identifying interest beneficiaries by potential donor parties and transmitting the conditional pledge to potential donor parties with interest in the beneficiary.

5. The method of claim 3 wherein potential donor parties are identified from contact information provided by the pledging party.

6. The method of claim 1 wherein the conditional pledge comprises matching all or a portion of donor funds.

7. A method of fundraising comprising:
providing a pledging party with an electronic platform to communicate an offer to donate to a cause of a donor party contingent upon a donation by the donor party being made to a cause affiliated with the pledging party;
providing a platform for the donor party to donate to the cause of the pledging party; and
providing a platform for the pledging party to donate to the cause of the donor party.

8. A method of claim 7 wherein the platform to communicate the offer comprises an electronically accessible website.

9. The method of claim 7 wherein funds relating to donations are held in escrow pending disbursement.

10. A method of providing escrow services including an electronic platform comprising:
establishing an escrow account;
electronically receiving funds from a first party to be held in the account;
electronically receiving funds from a second party to be held in the account; and
distributing funds in the account in accordance with instructions.

11. The method of claim 10 wherein a program manager can determine disbursement of the funds.
